(19) United States
(12) Patent Application Publication
(10) Pub. No.: US 2025/0222731 A1
(43) Pub. Date: Jul. 10, 2025

(54) TRACTOR AND METHOD OF DETECTING CONNECTION OF A TRAILER TO A TRACTOR

(71) Applicants: HYUNDAI MOTOR COMPANY, Seoul (KR); KIA CORPORATION, Seoul (KR); MOTLAB CO,. LTD, Yongin-si (KR); KYUNGSHIN CO., LTD., Incheon (KR)

(72) Inventors: Soon Cheol Hwang, Hwaseong-si (KR); Joon Hee Kim, Hwaseong-si (KR); Hyun Seok Kim, Siheung-si (KR); Ji Hoon Kim, Incheon (KR)

(73) Assignees: HYUNDAI MOTOR COMPANY, Seoul (KR); KIA CORPORATION, Seoul (KR); MOTLAB CO,. LTD, Yongin-si (KR); KYUNGSHIN CO., LTD., Incheon (KR)

(21) Appl. No.: 18/942,204

(22) Filed: Nov. 8, 2024

(30) Foreign Application Priority Data
Jan. 8, 2024 (KR) 10-2024-0002848

(51) Int. Cl. B60D 1/36; B60D 1/62; B60Q 11/00; B60R 16/027

(52) U.S. Cl. CPC B60D 1/36; B60D 1/62; B60Q 11/005; B60R 16/027

(57) ABSTRACT

A tractor and a method of sensing connection of a trailer to the tractor are provided. The trailer may include a plurality of lamps for informing a driver of a vehicle behind a tractor of the driving status of the tractor. The tractor may include a controller and a battery. The controller may sense that a set operation has been input by a driver. The controller may further determine to turn on all of the plurality of lamps as it senses that the set operation has been input. The controller may further determine whether the trailer is connected based on current output from the battery to turn on all of the plurality of lamps.

### CROSS-REFERENCE TO RELATED APPLICATIONS

The present application claims priority to Korean Patent Application No. 10-2024-0002848, filed on Jan. 8, 2024, the entire contents of which are incorporated herein for all purposes by this reference.

### TECHNICAL FIELD

The present disclosure relates to a tractor and a method of sensing connection of a trailer to a tractor.

### BACKGROUND

The statements in this section merely provide background information related to the present disclosure and may not constitute prior art.

In general, a tractor controls brake lights, left and right turn signal lamps, tail lights, and the like disposed on a trailer based on whether the trailer is connected to the tractor.

Conventionally, in order to determine whether a trailer was connected to a tractor, power was output to a brake light of the trailer when a driver stepped on a brake pedal, and the amount of current flowing through the output was measured.

However, such a conventional simple method has several limitations, especially two main problems.

First, when a light emitting diode (LED) lamp is applied to a trailer brake light, flowing current is so low that it may be impossible to completely determine whether the light is disconnected with an intelligent power switch (IPS) element.

In addition, because there is no way to know what trailer will be connected, it is not possible to reduce the output capacity of the IPS. In general, smaller currents can be sensed by using an IPS with a smaller capacity. In this case, however, the maximum output capacity is reduced, so it is not possible to support a large capacity lamp.

Second, when both left and right brake lights have been disconnected, it may be difficult to determine whether the brake lights have been disconnected or a trailer has not been connected.

The information included in this Background of the present disclosure section is only for enhancement of understanding of the general background of the present disclosure and may not be taken as an acknowledgement or any form of suggestion that this information forms the prior art already known to a person having ordinary skill in the art.

### SUMMARY

In view of the foregoing problems, a new method is required to determine whether a trailer is connected regardless of the capacity of a brake light.

The present disclosure is aimed at resolving at least one of the above-described problems.

An embodiment of the present disclosure is aimed at providing a tractor and a method for determining whether a trailer is connected regardless of the capacity of a brake light.

An embodiment of the present disclosure provides a method of determining connection of a trailer to a tractor. The method may include determining, by a controller, that a preset operation has been input by a driver. The method may further include determining, by the controller, to turn on all of a plurality of lamps of the trailer after determining that the preset operation has been input. The plurality of lamps may be configured to operate to inform a vehicle behind the tractor of a driving state of the tractor. The method may also include determining, by the controller, whether the trailer is connected, based on a current output from a battery to turn on all of the plurality of lamps.

The input of the preset operation may include turning on a brake pedal switch.

Determining whether the trailer is connected may include comparing a sum of variance in current of each of the plurality of lamps with a reference value. Determining whether the trailer is connected may further include determining whether the trailer is connected based on the comparison result.

The method may further include determining, by the controller, whether a turn signal lamp among the plurality of lamps is disconnected based on a current output from the battery to the turn signal lamp.

Determining whether the turn signal lamp is disconnected may include making a first determination as to whether the turn signal lamp is disconnected based on the current output to the turn signal lamp before determining whether the trailer is connected. Determining whether the turn signal lamp is disconnected may further include making a second determination as to whether the turn signal lamp is disconnected based on the current output to the turn signal lamp when the trailer is determined to be connected to the tractor.

Determining whether the turn signal lamp is disconnected may further include determining that the turn signal lamp is in a preliminary disconnection state when determining in the first determination that the turn signal lamp was disconnected. Determining whether the turn signal lamp is disconnected may further include outputting a notification regarding disconnection through a visual or auditory notification device when determining in the second determination that the turn signal lamp is disconnected after the turn signal lamp is determined to be in the preliminary disconnection state.

The method may further include storing, by the controller, the sum of variance in current in a memory when all lamps of the plurality of lamps are turned off.

The method may further include checking, by the controller, whether a trailer scanning mode is on or off upon (i.e., in response to) determining that the preset operation has been input. The method may further include turning on, by the controller, the trailer scanning mode when the trailer scanning mode is off.

The method may further include: checking, by the controller, whether a trailer scanning mode is on or off; checking, by the controller, whether the trailer is connected based on data stored in a memory; and checking, by the controller, whether a turn signal lamp among the plurality of lamps is disconnected.

Determining that the preset operation has been input by a driver is performed when the trailer scanning mode is on, the trailer is not determined to be connected based on the data stored in the memory, or the turn signal lamp among the plurality of lamps is determined to be disconnected through checking whether the turn signal lamp is disconnected.

An embodiment of the present disclosure may provide a tractor including a battery and a controller including a memory storing instructions for implementing a preset process and a processor configured to execute the instructions. The processor may be configured to cause, by executing the instructions, the controller to determine that a preset operation has been input by a driver and to determine to turn on all of a plurality of lamps of the trailer after it is determined that the preset operation has been input. The plurality of lamps may be configured to operate to inform a vehicle behind the tractor of a driving state of the tractor. The processor may be further configured to cause, by executing the instructions, the controller to determine whether the trailer is connected, based on a current output from a battery to turn on all of the plurality of lamps.

The input of the preset operation may include turning on a brake pedal switch.

In determining whether the trailer is connected, the processor may be configured to cause the controller to: compare a sum of variance in current of each of the plurality of lamps with a reference value; and determine whether the trailer is connected based on a result of the comparison.

The processor may be further configured to cause the controller to determine whether a turn signal lamp among the plurality of lamps is disconnected based on a current output from the battery to the turn signal lamp.

In determining whether the turn signal lamp is disconnected, the processor may be configured to cause the controller to: make a first determination as to whether the turn signal lamp is disconnected based on the current output to the turn signal lamp before determining whether the trailer is connected; and make a second determination as to whether the turn signal lamp is disconnected based on the current output to the turn signal lamp when the trailer is determined to be connected to the tractor.

In determining whether the turn signal lamp is disconnected, the processor may be further configured to cause the controller to: determine that the turn signal lamp is in a preliminary disconnection state when having determined in the first determination that the turn signal lamp was disconnected; and output a notification regarding disconnection through a visual or auditory notification device when determining in the second determination that the turn signal lamp is disconnected after the turn signal lamp is determined to be in the preliminary disconnection state.

The processor may be further configured to cause the controller to store the sum of variance in current in the memory when all of the plurality of lamps are turned off.

The processor may be further configured to cause the controller to: check whether a trailer scanning mode is on or off upon (i.e., in response to) determining that the preset operation has been input; and turn on the trailer scanning mode when the trailer scanning mode is off.

The processor may be further configured to cause the controller to check whether the trailer scanning mode is on or off, checks whether the trailer is connected based on data stored in a memory, and check whether a turn signal lamp among the plurality of lamps is disconnected.

The processor may be further configured to cause the controller to determine that the preset operation has been input when the trailer scanning mode is on, the trailer is not determined to be connected based on the data stored in the memory, or the turn signal lamp among the plurality of lamps is determined to be disconnected through checking whether the turn signal lamp is disconnected.

According to an embodiment of the present disclosure, it may be possible to determine whether a trailer is connected regardless of the capacity of a brake light.

Conventionally, whether a trailer was connected was determined solely based on the current from brake lights of the trailer, so it was impossible to determine whether the trailer was connected when the brake lights of the trailer were LED or disconnected.

However, according to an embodiment of the present disclosure, all lamps of a trailer may be turned on to determine whether the trailer is connected. Therefore, it may be possible to solve the problem of small currents not being sensed due to the application of LEDs or a current not being sensed due to some lamps being disconnected.

The methods and apparatuses of the present disclosure may have other features and advantages which should be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 conceptually shows components of a tractor according to an embodiment of the present disclosure.

FIG. 2 shows a rear view of what is shown in FIG. 1.

FIG. 3 conceptually shows a second controller according to an embodiment of the present disclosure.

FIG. 4 shows the structure of a connector for electrically connecting the tractor and a trailer according to an embodiment of the present disclosure.

FIGS. 5A and 5B are a flowchart for showing a method of sensing the connection of the trailer according to an embodiment of the present disclosure.

FIG. 6 shows current information for each socket number for the connector in FIG. 3.

FIGS. 7A and 7B show an example of current output to a lamp and its conversion to a hexadecimal (HEX) value obtained by an Analog to Digital (AD) converter.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes, will be determined in part by the particularly intended application and use environment.

In the figures, the same reference numerals refer to the same or equivalent parts of the present disclosure throughout the several figures of the drawing.

### DETAILED DESCRIPTION

Because various changes can be made to the present disclosure and a range of embodiments can be made for the present disclosure, specific embodiments are illustrated and described in the drawings. However, this is not intended to limit the present disclosure to the specific embodiments. It should be understood that the present disclosure includes all changes, equivalents, and substitutes within the technology and the scope of the present disclosure.

The terms “module” and “unit” used in the present disclosure are merely used to distinguish the names of components and should not be interpreted as assuming that the components have been physically or chemically separated or can be so separated.

Terms containing ordinal numbers such as “first” and “second” may be used to describe various components, but the components are not limited by the terms. The above-mentioned terms can be used only as names to distinguish one component from another component. The order therebetween can be determined by the context in the descriptions thereof, not by such names.

The expression “and/or” is used to include all possible combinations of multiple items being addressed. For example, by “A and/or B,” all three possible combinations are meant: “A,” “B,” and “A and B.”

When a component is said to be “coupled” or “connected” to another component, it means that the component may be directly coupled or connected to the other component or there may be other components therebetween.

The terms used herein are only used to describe specific embodiments and are not intended to limit the present disclosure. Expressions in the singular form include the meaning of the plural form unless they clearly mean otherwise in the context. In the present disclosure, expressions such as “comprise,” “include,” or “have” are intended to indicate the presence of features, numbers, steps, operations, components, parts, or combinations thereof described herein, and should not be understood as precluding the possibility of the presence or the addition of one or more other features, numbers, steps, operations, components, parts, or combinations thereof.

Unless otherwise defined, all terms used herein, including technical or scientific terms, have meanings commonly understood by a person having ordinary skill in the art to which the present disclosure pertains. Terms defined in commonly used dictionaries should be interpreted as having meanings consistent with the meanings they have in the context of the relevant technology and should not be interpreted in an ideal or overly formal sense unless explicitly defined in the present disclosure.

In addition, a unit, a control unit, a control device, or a controller is only a term widely used to name devices for controlling a certain function, and do not mean a generic function unit. For example, devices with these names may include a communication device that communicates with other controllers or sensors to control a certain function, a computer-readable recording medium that stores an operating system, logic instructions, input/output information, and the like, and one or more processors that perform operations of determination, calculation, making decisions, and the like required to control the function. When a component, unit, module, processor, controller, device, element, apparatus, or the like of the present disclosure is described as having a purpose or performing an operation, function, or the like, the component, unit, module, processor, controller, device, element, apparatus, or the like should be considered herein as being “configured to” meet that purpose or to perform that operation or function.

The processor may include a semiconductor integrated circuit and/or electronic devices that carry out operations of at least one of comparison, determination, calculation, and making decisions to perform a programmed function. For example, the processor may be any one or a combination of a computer, a microprocessor, a central processing unit (CPU), an application-specific integrated circuit (ASIC), and an electronic circuit such as circuitry and logic circuits.

Examples of a computer-readable recording medium (or simply called a memory) may include all types of storage devices for storing data that can be read by a computer system. For example, they may include at least one of a memory such as a flash memory, a hard disk, a micro memory, and a card memory, e.g., a secure digital card (SD card) or an eXtream digital card (XD card), and a memory such as a random access memory (RAM), a static ram (SRAM), a read-only memory (ROM), a programmable ROM (PROM), an electrically erasable PROM (EEPROM), a magnetic RAM (MRAM), a magnetic disk, and an optical disk.

Such a recording medium may be electrically connected to the processor, and the processor may load and write data from the recording medium. The recording medium and the processor may be integrated or physically separate.

Hereinafter, the accompanying drawings are briefly described, and embodiments of the present disclosure are described in detail with reference to the drawings.

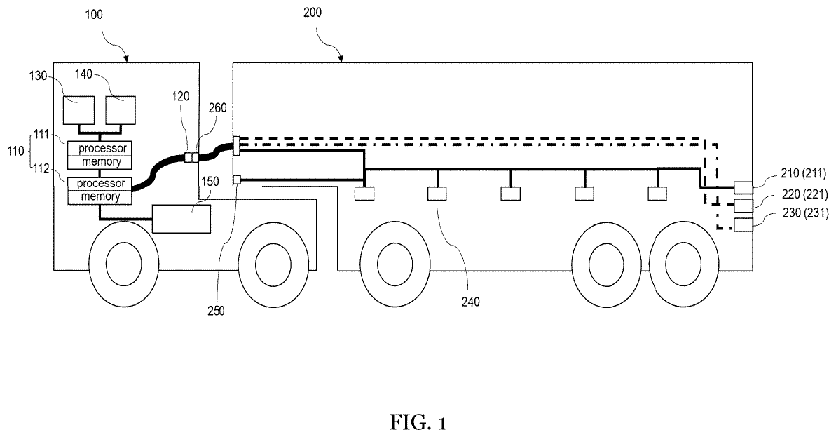

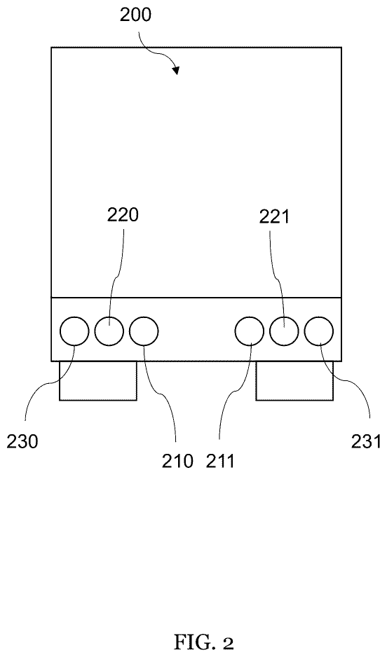

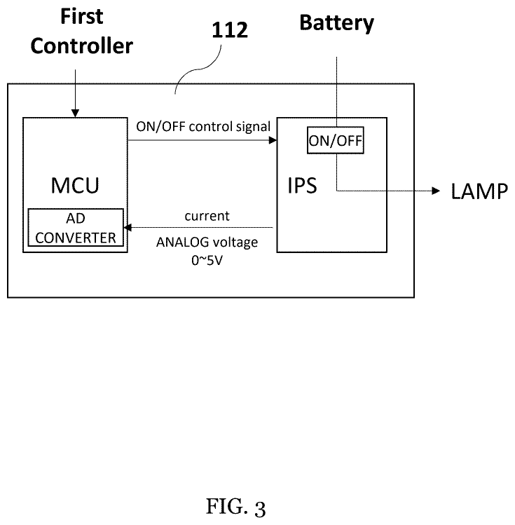

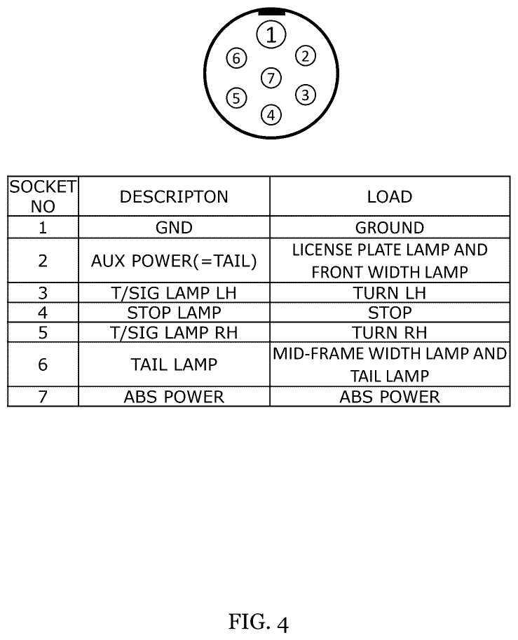

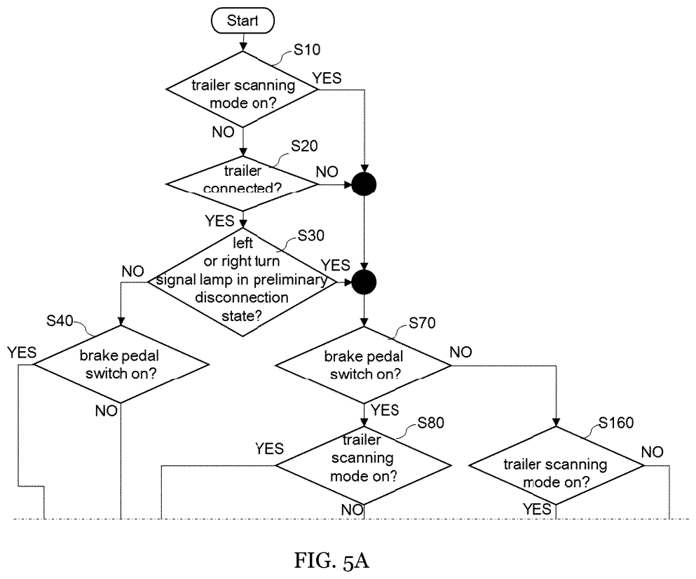

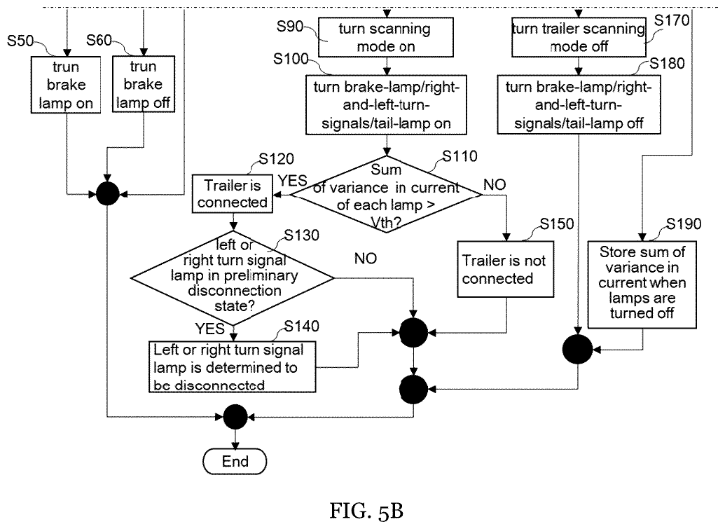

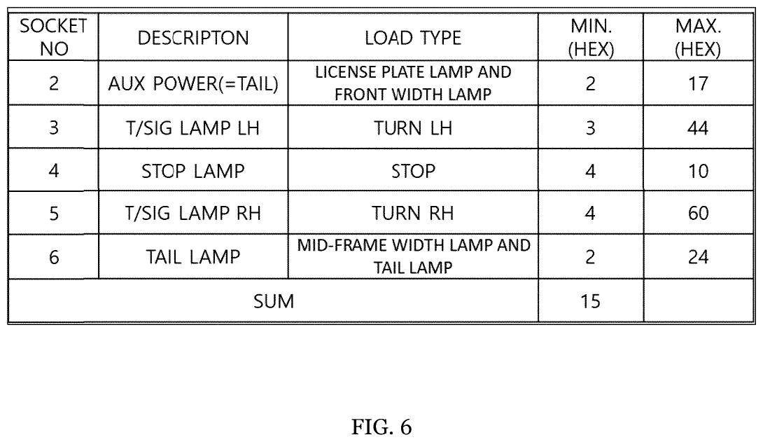

FIG. 1 conceptually shows components of a tractor 100 according to an embodiment of the present disclosure. FIG. 2 shows a rear view of what is shown in FIG. 1. In addition, FIG. 3 conceptually shows a second controller 112 according to an embodiment of the present disclosure. FIG. 4 shows the structure of a connector for electrically connecting the tractor 100 and a trailer 200 according to an embodiment of the present disclosure. FIG. 5 is a flowchart for showing a method of sensing the connection of the trailer 200 according to an embodiment of the present disclosure. FIG. 6 shows current information for each socket number for the connector in FIG. 3.

Referring to FIGS. 1 and 2, the tractor 100 according to an embodiment may include a controller 110, a brake pedal switch 130, a visual or auditory notification device 140, and a battery 150.

The controller 110 may include a first controller 111 and a second controller 112.

The first controller 111 may receive an on or off signal from the brake pedal switch 130. When a driver gets in a vehicle and steps on a brake pedal, the brake switch may transmit an on signal to the first controller 111. When the brake pedal returns unpressed, the brake switch may transmit an off signal to the first controller 111.

In addition, when a left turn signal lamp 230 or a right turn signal lamp 231 is disconnected, the first controller 111 may control the visual or auditory notification device 140 to notify a driver of the disconnection.

For example, when a driver pushes down a turn signal switch to change to the right lane or turn right, a right turn signal on signal may be transmitted to the first controller 111. Furthermore, when the driver moves the turn signal switch upward, a left turn signal on signal may be transmitted to the first controller 111.

The second controller 112 may control the output of the battery 150 according to commands from the first controller 111 to supply power to the trailer 200.

The second controller 112 may be a smart junction box (SJB) or a power-net domain controller (PDC).

In addition, the second controller 112 may be an integrated central control unit (ICU).

The ICU may include a micro control unit (MCU), which performs logic input/output, control logic operations, and the like and which controls the components of the ICU. The ICU may also include: a regulator that converts the power of the battery 150 into a low voltage, a direct current (DC) voltage; a Multiple Switch Detection Interface IC (MSDI), which serves as a multiplex in sensing the input of analog switches; an IPS, which controls electrical output for loads, diagnoses the cause of lamp failure, and maintains constant voltage; and a controller area network (CAN) transceiver responsible for input and output of CAN communication signals.

Because the type or quantity of lamps of the trailer 200 may vary depending on its manufacturer, and the features thereof may vary depending on the time when it was manufactured, it is realistically impossible to determine the specifications of all types of the trailer 200.

In addition, the lamps of the trailer 200 may be bulbs, at least some thereof may be LEDs, and the quantity and capacity of the lamps may also vary.

Therefore, it may be desirable to select an output device with a relatively high output capacity in the step of selecting an output device of the second controller 112 so that it may be possible for the second controller 112 to cover all types of the trailer 200.

Referring to FIG. 3, the MCU of the second controller 112 may receive a control signal from the first controller 111 and transmit the control signal to the IPS.

The IPS may connect or disconnect the power of the battery 150 to the lamps of the trailer 200 according to the on/off signal of the received control signal.

While outputting the power to the lamps, the IPS may determine the current amount and the voltage of each lamp and transmit information thereon to the MCU.

In this embodiment, the first controller 111 and the second controller 112 may include a memory storing a program code of a set process and a processor executing the process, as described above.

Furthermore, the second controller 112 may include a first connector 120 to be electrically connected to the trailer 200.

The trailer 200 may include a second connector 260 detachably connected to the first connector 120, and power may be supplied from the battery 150 of the tractor 100 to the trailer 200 through an electrical connection between the first connector 120 and the second connector 260.

In addition, the trailer 200 may include tail lamps 210 and 211, brake lights 220 and 221, and turn signal lamps 230 and 231, which are arranged in pairs on the left and right sides of the rear.

Furthermore, the trailer 200 may include a front side light 250 on the front and a side marker 240 on the side.

FIG. 4 illustrates a socket structure for the first connector 120 according to an embodiment, which is described below.

First, socket number 1 may be a ground. Socket number 2 may be auxiliary power and responsible for an electrical connection to a license plate light and front side lights.

In addition, socket number 3 may be responsible for the left turn signal lamp 230. Socket number 4 may be responsible for the brake lights 220 and 221. Socket number 5 may be responsible for the right turn signal lamp 231.

Lastly, socket number 6 may be responsible for the tail lamps 210 and 211. Socket number 7 may be responsible for powering an anti-lock brake system (ABS).

FIGS. 5A and 5B show a flowchart of a method of sensing the connection of the trailer 200 to the tractor 100 through the above-described controller 110, which is described in detail below.

First, at S10, the controller 110 may check a trailer scanning mode.

In the trailer scanning mode, all lamps of the trailer 200 may be turned on to determine whether the trailer 200 has been connected.

When the trailer scanning mode is on at S10, the controller 110 may perform S70, which is described below.

When the trailer scanning mode is off at S10, the controller 110 may check whether the trailer 200 is connected by checking information on whether the trailer 200 is connected stored in a memory at S20.

When it is not determined at S20 that the trailer 200 is connected, the controller 110 may perform S70.

When it is determined that the trailer 200 is connected at S20, a first determination may be made at S30 as to whether the left or right turn signal lamp 230 and 231 of the trailer 200 is disconnected. For example, when it is determined that the left or right turn signal lamp 230 and 231 of the trailer 200 is disconnected based on the information stored in the memory, the controller 110 may determine that the corresponding lamp is in a preliminary disconnection state.

When at least one of the left and right turn signal lamps 230 and 231 is determined to be in the preliminary disconnection state at S30, the process may proceed to S70, otherwise, to S40.

At S40, the controller 110 may determine whether the brake pedal switch 130 is on.

In addition, when the brake pedal switch 130 is on at S40, it may be determined to switch on the brake lights 220 and 221 of the trailer 200. When it is off at S40, it may be determined to switch off them.

The controller 110 may determine whether the brake pedal switch 130 is on at S70, and, if so, the process may proceed to S80, otherwise, to S160.

When it is determined that the trailer scanning mode is on at S80, the control may end; otherwise, the trailer scanning mode may be turned on at S90.

In addition, at S100, the controller 110 may switch on all the lamps of the trailer 200, such as the brake lights 220 and 221, the left and right turn signal lamps 230 and 231, and the tail lamps 210 and 211.

At S110, the controller 110 may check variance in current of each lamp and determine whether the total sum thereof exceeds a reference value.

As described above, the specifications of the trailer 200 vary depending on its manufacturer, the time when it has been produced, and the country where it has been manufactured. Nevertheless, disconnection of the turn signal lamps 230 and 231 of the trailer 200 needs to be sensed when the trailer 200 has been connected, so it may be necessary to first sense that the trailer 200 has been connected.

FIG. 6 shows data on the level of minimum capacity of lamps that can be installed on the trailer 200 according to an embodiment of the present disclosure. This has been obtained by analyzing a log of information on current input when the lamps of the trailer 200 are turned on.

As shown in FIG. 6, the sum of the minimum current of each lamp is the HEX value 15, so a reference value may be determined based thereon. For example, the HEX value 10, which is approximately 70 percent of the HEX value 15, may be selected as the reference value.

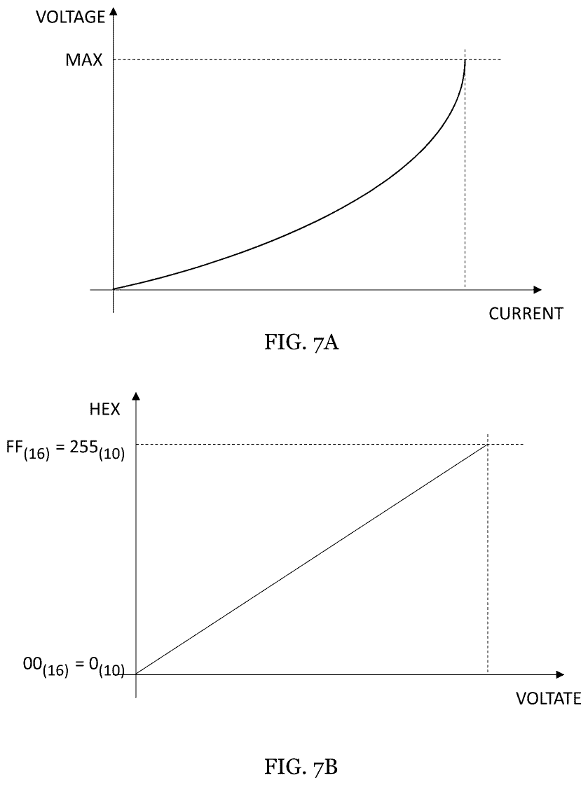

For reference, FIGS. 7A and 7B show an example of current output to a lamp and its conversion to a hexadecimal (HEX) value obtained by an Analog to Digital (AD) converter. FIG. 7A shows the current and the voltage output to the lamp in FIG. 3. FIG. 7B shows values converted from the current by the AD converter of the MCU.

In other words, current and voltage output to a lamp may be converted to HEX values in the MCU through the AD converter, as shown in FIGS. 7A and 7B.

Referring back to FIGS. 5A and 5B, when determining that the total sum of variance in current of each lamp exceeds a reference value at S110, the controller 110 may determine that the trailer 200 is connected at S120. In this case, the controller 110 may store data showing that the connection of the trailer 200 is on in a memory.

Next, the controller 110 may determine whether the left or right turn signal lamp 230 and 231 of the trailer 200 is in the preliminary disconnection state at S130. At S140, the controller 110 may make a secondary determination as to whether the left or right turn signal lamp 230 and 231 is disconnected based on current output to the left or right turn signal lamp 230 and 231 and finally determine whether it is disconnected.

When it is finally determined at S140 that the left or right turn signal lamp 230 and 231 is disconnected, the controller 110 may notify a driver of the disconnection in a visual or auditory manner through the notification device 140.

For example, the auditory notification device 140 may be a speaker, and the visual notification device 140 may be a dashboard.

The process in S130 is included to determine whether the left or right turn signal lamp 230 and 231 is disconnected, but the results obtained in the preceding S30 may be applied as they are.

When the left or right turn signal lamp 230 and 231 is not determined to be in the preliminary disconnection state at S130, the logic may end, skipping S140 where it is finally determined whether the left or right turn signal lamp 230 and 231 is disconnected.

When determining that the total sum of variance in current of each lamp is equal to or less than a reference value at S110, the controller 110 may not determine at S150 that the trailer 200 is connected and may store data showing that the connection of the trailer 200 is off in a memory.

When it is not determined that the brake pedal switch 130 is on at S70, the controller 110 may determine whether the trailer scanning mode is on at S160.

When the trailer scanning mode is not determined to be on at S160, the process may move on to S190, otherwise, the trailer scanning mode may be turned off at S170.

In addition, at S180, the controller 110 may switch off all the lamps of the trailer 200, such as the brake lights 220 and 221, the left and right turn signal lamps 230 and 231, and the tail lamps 210 and 211.

In the meantime, the controller 110 may check variance in current when each lamp is turned off, calculate the total sum thereof, and store it in a memory at S190. The above-mentioned reference value may be determined based on the total sum of variance in current at the time of turning off each lamp.

In this embodiment, S40 and S70 are an example of input of a set operation by a driver, and the embodiment is not limited thereto. In this embodiment, a brake pedal pressed by a driver is a trigger for carrying out a set process of determining whether the trailer 200 is connected, but the operation as the trigger is not necessarily pressing a brake pedal.

Embodiments of the present disclosure have been described. It should be apparent to a person having ordinary skill in the art that the present disclosure can be embodied in other specific forms in addition to the embodiments described above within its technology or scope. Therefore, the above-described embodiments are to be deemed illustrative and not restrictive. The present disclosure is not limited to the description but may be modified within the scope of the appended claims and their equivalents.

What is claimed is:

1. A method of determining connection of a trailer to a tractor, the method comprising:
determining, by a controller, that a preset operation has been input by a driver;
determining, by the controller, to turn on all of a plurality of lamps of the trailer after determining that the preset operation has been input, the plurality of lamps being configured to operate to inform a vehicle behind the tractor of a driving state of the tractor; and
determining, by the controller, whether the trailer is connected, based on a current output from a battery to turn on all of the plurality of lamps.

2. The method of claim 1, wherein the input of the preset operation includes turning on a brake pedal switch.

3. The method of claim 1, wherein determining whether the trailer is connected includes:
comparing a sum of variance in current of each of the plurality of lamps with a reference value; and
determining whether the trailer is connected based on a result of the comparison.

4. The method of claim 3, further comprising determining, by the controller, whether a turn signal lamp among the plurality of lamps is disconnected based on a current output from the battery to the turn signal lamp.

5. The method of claim 4, wherein determining whether the turn signal lamp is disconnected includes:
making a first determination as to whether the turn signal lamp is disconnected based on the current output to the turn signal lamp before determining whether the trailer is connected; and
making a second determination as to whether the turn signal lamp is disconnected based on the current output to the turn signal lamp when the trailer is determined to be connected to the tractor.

6. The method of claim 5, wherein determining whether the turn signal lamp is disconnected further includes:
determining that the turn signal lamp is in a preliminary disconnection state when determining in the first determination that the turn signal lamp is disconnected; and
outputting a notification regarding disconnection through a visual or auditory notification device when determining in the second determination that the turn signal lamp is disconnected after the turn signal lamp is determined to be in the preliminary disconnection state.

7. The method of claim 3, further comprising storing, by the controller, the sum of variance in current in a memory when all lamps of the plurality of lamps are turned off.

8. The method of claim 1, further comprising:
checking, by the controller, whether a trailer scanning mode is on or off upon determining that the preset operation has been input; and
turning on, by the controller, the trailer scanning mode when the trailer scanning mode is off.

9. The method of claim 1, further comprising:
checking, by the controller, whether a trailer scanning mode is on or off;
checking, by the controller, whether the trailer is connected based on data stored in a memory; and
checking, by the controller, whether a turn signal lamp among the plurality of lamps is disconnected.

10. The method of claim 9, wherein determining that the preset operation has been input by the driver is performed when the trailer scanning mode is on, the trailer is not determined to be connected based on the data stored in the memory, or the turn signal lamp among the plurality of lamps is determined to be disconnected through checking whether the turn signal lamp is disconnected.

11. A tractor comprising:
a controller including a memory storing instructions for implementing a preset process and a processor configured to execute the instructions; and
a battery,
wherein the processor is configured to cause, by executing the instructions, the controller to
determine that a preset operation has been input by a driver,
determine to turn on all of a plurality of lamps of a trailer after determining that the preset operation has been input, the plurality of lamps being configured to operate to inform a vehicle behind the tractor of a driving state of the tractor, and
determine whether the trailer is connected, based on a current output from a battery to turn on all of the plurality of lamps.

12. The tractor of claim 11, wherein the input of the preset operation includes turning on a brake pedal switch.

13. The tractor of claim 11, wherein in determining whether the trailer is connected, the processor is configured to cause the controller to:
compare a sum of variance in current of each of the plurality of lamps with a reference value; and
determine whether the trailer is connected based on a result of the comparison.

14. The tractor of claim 13, wherein the processor is further configured to cause the controller to determine whether a turn signal lamp among the plurality of lamps is disconnected based on a current output from the battery to the turn signal lamp.

15. The tractor of claim 14, wherein in determining whether the turn signal lamp is disconnected, the processor is configured to cause the controller to:
make a first determination as to whether the turn signal lamp is disconnected based on the current output to the turn signal lamp before determining whether the trailer is connected; and
make a second determination as to whether the turn signal lamp is disconnected based on the current output to the turn signal lamp when the trailer is determined to be connected to the tractor.

16. The tractor of claim 15, wherein in determining whether the turn signal lamp is disconnected, the processor is further configured to cause the controller to:
determine that the turn signal lamp is in a preliminary disconnection state when determining in the first determination that the turn signal lamp was disconnected; and
output a notification regarding disconnection through a visual or auditory notification device when determining in the second determination that the turn signal lamp is disconnected after the turn signal lamp is determined to be in the preliminary disconnection state.

17. The tractor of claim 13, wherein the processor is further configured to cause the controller to store the sum of variance in current in the memory when all lamps of the plurality of lamps are turned off.

18. The tractor of claim 11, wherein the processor is further configured to cause the controller to:
check whether a trailer scanning mode is on or off upon determining that the preset operation has been input; and
turn on the trailer scanning mode when the trailer scanning mode is off.

19. The tractor of claim 11, wherein the processor is further configured to cause the controller to:
check whether a trailer scanning mode is on or off;
check whether the trailer is connected based on data stored in a memory; and
check whether a turn signal lamp among the plurality of lamps is disconnected.

20. The tractor of claim 19, wherein the processor is further configured to cause the controller to determine that the preset operation has been input when the trailer scanning mode is on, the trailer is not determined to be connected based on the data stored in the memory, or the turn signal lamp among the plurality of lamps is determined to be disconnected through checking whether the turn signal lamp is disconnected.
